(19) United States
(12) Patent Application Publication
(10) Pub. No.: US 2012/0141956 A1
(43) Pub. Date: Jun. 7, 2012

(54) METHOD FOR FIXED CROWN AND BRIDGE RESTORATIVE CASES USING ENDO-POST DENTAL IMPLANT SYSTEM (I-LOC) WITH SCREWLESS ABUTMENT FASTENING WITHIN IMPLANT AND WITH MULTIPLE IMPLANTS WITH TRY-IN HEADS

(76) Inventor: Charles S. Mandell, Hollywood, FL (US)

(21) Appl. No.: 13/226,406

(22) Filed: Sep. 6, 2011

Related U.S. Application Data
(62) Division of application No. 12/215,864, filed on Jun. 30, 2008, now abandoned.
Application No. 12/215,864 is a continuation-in-part of application No. 11/479,040, filed on Jun. 30, 2006, now abandoned.
Application No. 11/479,040 is a continuation-in-part of application No. 10/793,617, filed on Mar. 5, 2004, now abandoned.

(51) Int. Cl. A61C 13/02; A61C 13/225

(52) U.S. Cl. 433/199.1

(57) ABSTRACT

A dental implant system with screwless abutment fastening within an implant includes an implant having a tubular implant side wall and an implant bottom wall sealingly secured to the implant side wall for surgical insertion into the jaw of a patient; and an abutment having a cylindrical abutment anchor portion for insertion into the tubular implant side wall having a lateral projection for engaging the tubular implant side wall and thereby retaining the abutment against rotation relative to the implant, and having a prosthetic tooth abutment mounting portion. The implant side wall has an implant side wall inward surface which includes a circumferential series of spline receiving grooves registering with the series of splines for receiving the series of splines upon insertion of the abutment anchor portion into the implant.

### FILING HISTORY

This application is a divisional of application Ser. No. 12/215,864, filed on Jun. 30, 2008, which is a continuation-in-part of application Ser. No. 11/479,040, filed on Jun. 30, 2006, and of application Ser. No. 10/793,617 filed on Mar. 5, 2004.

### BACKGROUND OF THE INVENTION

2. Field of the Invention

The present invention relates generally to the field of prosthesis design and construction. More specifically the present invention relates to a screwless coupled endo-post dental implant system including an implant having a tubular implant side wall and an implant bottom wall for surgical insertion into the jaw of a patient, and an abutment having self-locking splines for direct insertion into an equal number of grooves in the implant after the jaw heals, the abutment being thereby secured within the implant without use of a screw or any other threaded fastening means. As a result, the abutment is a solid cylinder having maximum tensile and sheer strength because no screw bore is needed, and the abutment is secured quickly and easily without need of fastener securing tools. A crown prosthesis referred to hereinafter as a prosthetic tooth is mounted on the abutment. The abutment is secured within the implant with a tri-support seal to minimize micromovement and thus to enhance stability and to transfer occusol forces longitudinally down the implant. The tri-support seal has apical, longitudinal and coronal aspects.

The apical aspect of the tri-support seal includes a abutment pilot tip which fits with close tolerance into a corresponding implant internal bevel at the implant embedded end. The abutment is pilot tip and the implant internal bevel serve to properly self-center the abutment during insertion and to enhance abutment strength.

The longitudinal aspect of the tri-support seal includes the above referenced, mutually engaging equally numbered spline and groove structures between the implant and abutment. The implant side wall inward surface has a circumferential series of longitudinally extending spline grooves and the abutment includes a cylindrical abutment anchor portion having a corresponding circumferential series of longitudinally extending splines which slide into the spline receiving grooves as the abutment is inserted, securely retaining the abutment against rotation relative to the implant and jaw. The number of splines matches the number of grooves. The self-locking splines have an E-Z Grip or Auto Grip characteristic.

The coronal aspect of the tri-support seal includes an anti-intrusion bio-seal. The bio-seal preferably involves simply machining the abutment and the implant with close tolerances so that they fit together precisely.

There is no need to counterbore or countersink, and thus no counterbore or countersink tooling is required. Drill to the implant support platform size of 3 mm-6 mm or more, but these sizes are merely exemplary and are not to be construed as limiting. The major diameter of the external thread is designed to support this feature. It is larger than the support platform.

The abutment has a prosthetic tooth mounting portion integral with and extending upwardly from the abutment anchor portion and which fits into a correspondingly shaped opening in the lower end of a prosthetic tooth or crown. The mounting portion preferably has a truncated rectangular cross-section pyramid shape. The implant side wall outward surface has implant external threads for rapid and secure seating on the jaw bone. The implant external threads preferably are quick-seat external threads having a high pitch so that the implant seats with as few as two rotations, rather than fifteen for example. The preferred pitch is 0.240, although this particular pitch should not be viewed as limiting because many other pitches are contemplated as well. Another preferred characteristic of the implant external threads is that they be multi-helix threads. This means that each thread as a wide enough spacing between its revolutions about the implant that one or more additional and matching threads can be interspersed between the given thread in parallel relation. Multi-helix threads have the advantage of multiple starts at the implant inserted end, for circumferentially distributed points of jaw bone engagement for even and balanced bite and advancement, and multiplied engagement strength. The implant preferably has a multi-flute, tapered self-tapping apical point to more easily bore into and seat itself within the jaw bone.

Where the implant is inserted into the jaw at an angle deviating from vertical, whether intentionally or by accident, and tooth mounting portion preferably is tilted or pre-bent to compensate for this angle of insertion. The mounting portion is alternatively vertically upright. The base of the tooth mounting portion preferably is wider than the anchor portion to abut the protruding end of the implant side wall upon full abutment insertion.

2. Description of the Prior Art

There have long been dental implant systems for securing to a patient jaw and mounting a prosthetic tooth. A problem with these prior systems has been that they do not provide a reliable and yet simple and easy to install mechanism for preventing rotation of an abutment and tooth relative to the implant.

Kirsch, et al., U.S. Pat. No. 6,116,904, issued on Sep. 12, 2000, discloses an endosteal single tooth implant secured against torsion, stamping tool and positioning aid for producing such a single tooth implant. A cylindrical basic element is placed in a bore in a jaw bone and has a spacer sleeve that can be placed on a coronal frontal edge of the basic element to be secured against rotation. A bore is provided in the sleeve into which an implant post is inserted to penetrate at least partially into the spacer sleeve. A problem with Kirsch, et al., is that the splines do not extend the length of the abutment. In fact. Kirsch splines cannot extend the full length of the abutment, because the splines extend along an outwardly protruding shoulder. As a result, the splines are not long enough to dissipate the large forces placed on the abutment along the length of the implant. All the force and stress is concentrated at the neck and the abutment can fracture at the shoulder. It also can fracture at the screw thread bore so that the incorporation of a screw and screw bore compromises the integrity and strength of the abutment and implant. The use of a screw is still further unsuitable because the cyclical application of loading to the abutment as would happen during chewing would tend to work the screw loose, and because screw threads in general make only fifty percent contact and the screw can break and strip, making the screw the weakest link in the system. Finally, inserting a screw is yet a further step to perform during initial abutment installation and during maintenance removal and replacement thereafter.

Duerr, et al., U.S. Pat. No. 5,823,776, issued on Oct. 20, 1998, teaches an endoseal single tooth implant with twisting prevention. Duerr, et al., includes a single tooth implant having a basic body, a spacing sleeve and means for preventing the basic body from twisting relative to the spacing sleeve. The basic body includes a blind bore forming a body coronal end, and a positive connection area adjacent to the coronal end, followed by a guide portion with a cylindrical surface and a centering area.

James, U.S. Pat. No. 5,269,686, issued on Dec. 14, 1993, reveals a threaded drivable dental implant having long pitch threads permitting the implant to be driven by axially delivered blows into a pre-drilled hole in the bone. The long pitch threads resist rotation forces when rotational forces are placed on the implant when attaching or removing the prosthesis.

Kumar, et al., U.S. Patent Publication Number 2004/0038178, published on Feb. 26, 2004, shows a healing abutment which optionally includes a snapping portion for snapping into, or a friction fit for entering and frictionally engaging a corresponding recess in a dental implant. A problem with Kumar, et al., as well with all of the cited art, is that insertion of the abutment into the implant is tedious because the abutment and implant must be carefully and precisely aligned first. The bevel of Kumar, et al., is not useful for centering and does not function to start the abutment into the implant because the bevel is not at the abutment distal or lower end.

Brainin, U.S. Pat. No. 3,849,887, issued on Nov. 26, 1974, discloses a dental implant including substantially nonporous, isotropic carbon having a textured and dentated lower portion and at least one expanded groove to assure immobility during alveolar bone ingrowth. The implant has an axial bore for receiving an anchor stem of an artificial crown.

Pillet, U.S. Pat. No. 3,863,344, issued on Feb. 4, 1975, teaches an implantable dental support for a dental prosthesis. Pillet includes a resilient envelope constructed of organosilicic elastomer so that the envelope outer surface is colonizable by surrounding living tissue implanted in a patient jaw and a stainless steel pin within the envelope.

Mohammed, U.S. Pat. No. 4,270,905, issued on Jun. 2, 1981, reveals a replacement system for dental and other bone implants. including a cylindrical core component for transmitting the masticatory load to a root system made up of a tubular outer component adhering to the jawbone and a tubular intermediate component adhering tightly to the core component and to the outer component.

Driskell, et al., U.S. Pat. No. 3,950,850, issued on Apr. 20, 1976, discloses'a dental prosthetic implant including a base having side walls with a series of circumferential horizontal ridges and a post extending upwardly from the base for mounting a crown prosthesis. A version of Driskell, et al. is provided having an angle between the post and the base.

Child, U.S. Pat. No. 4,195,409, issued on Apr. 1, 1980, teaches a dental implant including a crown and a root having a cone-shaped head fitted into a recess in the bottom of the crown, and a stem extending into the socket surrounded by and bonded to an elastic body of ethylene vinyl acetate copolymer. The elastic body outer surface is bonded to a porous fabric so that bone ingrowth can anchor the prosthesis to the mandible.

Ross, U.S. Pat. No. 4,744,755, issued on May 17, 1988, reveals a dental implant and a method for installing the implant. The implant includes a cylindrical body having a cylindrical cavity for receiving a cylindrical bone core. Several throughholes are provided in the body communicating with the cavity so that bone tissue growth can enter the throughholes. The outer surface of the body includes several reservoir structures for storing blood adjacent to the surrounding bone.

Ogino, et al., U.S. Pat. No. 4,424,037, issued on Jan. 3, 1984, discloses a dental implant including a core covered at least partly by a coating layer of biologically active glass for embedding in the jawbone. The coating layer includes separate, spaced apart portions.

It is thus an object of the present invention to provide an endo-post dental implant system including a tubular implant having a tubular implant side wall for surgical insertion into the jaw of a patient and an abutment for insertion into the implant after the jaw heals and spline means between the implant and the abutment for preventing rotation of the abutment relative to the implant and jaw.

It is another object of the present invention to provide such an endo-post dental implant system which does not have and does not need a threaded fastening means to secure the abutment into the implant, and therefore having a solid cylindrical abutment which is much stronger than an implant containing a fastener passing bore.

It is a further object of the present invention to provide such an endo-post dental implant system which has a self-centering abutment pilot tip for fitting into an implant internal bevel for greater implant strength and stability.

It is yet another object of the present invention to provide such an endo-post dental implant system which is partially or totally edentulous.

It is still another object of the present invention to provide such an endo-post dental implant system which can stand alone or be part of a bridge.

It is a still further object of the present invention to provide a method of installation using temporary prothesis correction heads, which provides the benefit of proper alignment of the try-in heads so as to establish parallelism of the abutment heads prior to taking the impression. These heads then act as the impression heads, which can be submitted to the dental lab for final alignment of the final fixed abutment heads, which can now be completed in the laboratory on stone casts so as to avoid excessive heat and drilling an the abutment heads while still in the mouth to establish proper parallelism.

It is finally an object of the present invention to provide such an endo-post dental implant system which is simple in design, sturdy and durable, easy to install and relatively inexpensive to manufacture and such a method which is easy to practice.

### SUMMARY OF THE INVENTION

The present invention accomplishes the above-stated objectives, as well as others, as may be determined by a fair reading and interpretation of the entire specification.

A dental implant system is provided, including an implant having a tubular implant side wall and an implant bottom wall sealingly secured to the implant side wall for surgical insertion into the jaw of a patient; and an abutment having a cylindrical abutment anchor portion for insertion into the tubular implant side wall having a lateral projection for engaging the tubular implant side wall and thereby retaining the abutment against rotation relative to the implant, and having a prosthetic tooth abutment mounting portion.

The lateral projection preferably includes a spline extending substantially longitudinally along the abutment anchor portion. The lateral projection preferably further includes a circumferential series of splines, each spline extending substantially longitudinally along the abutment anchor portion. The implant side wall has an implant side wall inward surface which preferably includes a circumferential series of longitudinally extending spline receiving grooves corresponding and registering with the series of splines for receiving the series of splines upon insertion of the abutment anchor portion into the implant. The abutment mounting is portion preferably has a truncated rectangular cross-section pyramid shape. The abutment mounting portion optionally is tilted relative to the abutment anchor portion, where the implant is placed, whether intentionally or by accident, in the jaw at an angle. The tooth mounting portion preferably has a tooth mounting portion base which is wider than the anchor portion so that the tooth mounting portion base abuts the implant side wall upon full insertion of the abutment anchor portion into the implant.

A dental implant system is further provided, including an abutment having a cylindrical abutment anchor portion and a prosthetic tooth mounting portion; an implant having a tubular implant side wall for receiving the abutment anchor portion and an implant bottom wall sealingly secured to the implant side wall, for surgical insertion into the jaw of a patient, the implant side wall having in implant side wall inward surface comprising a lateral projection for engaging the abutment anchor portion and thereby retaining the abutment against rotation relative to the implant.

The lateral projection preferably includes a spline extending substantially longitudinally along the implant side wall inward surface. The lateral projection preferably further includes a circumferential series of splines, each spline extending substantially longitudinally along the implant side wall inward surface. The abutment anchor portion preferably includes a circumferential series of longitudinally extending spline receiving grooves corresponding and registering with the series of splines for receiving the series of splines upon insertion of the abutment anchor portion into the implant. The abutment mounting portion has a truncated rectangular cross-section pyramid shape. The abutment mounting portion optionally is tilted relative to the abutment anchor portion in the event that the implant is placed in the jaw at an angle. The tooth mounting portion preferably has a tooth mounting portion base which is wider than the anchor portion; so that the tooth mounting portion base abuts the implant side wall upon full insertion of the abutment anchor portion into the implant.

A dental implant system is still further provided, including an implant having a tubular implant side wall for surgical insertion into the jaw of a patient; and an abutment having a cylindrical abutment anchor portion for insertion into the tubular implant side wall; and lateral projection structure between the implant side wall and the abutment for retaining the abutment against rotation relative to the implant.

The abutment is a solid cylinder, having no bores for threaded fasteners. The implant preferably has implant external threads for rotational insertion and fastening into a patient jaw bone. The implant external threads preferably have a pitch of at least 0.20 for seating into a patient jaw bone with a minimal number of implant rotations. The implant external threads preferably are multiple helical threads including at least two parallel and adjacent threads. The implant preferably includes an implant embedded end for insertion into a patient jaw bone, and the implant embedded end preferably includes a self tapping apical point. The abutment preferably includes an abutment pilot tip for insertion into the implant and the implant bottom wall preferably includes an implant internal bevel sized and positioned for receiving the abutment pilot tip, causing the abutment to self-center as the abutment is seated within the implant.

### BRIEF DESCRIPTION OF THE DRAWINGS

Various other objects, advantages, and features of the invention will become apparent to those skilled in the art from the following discussion taken in conjunction with the following drawings, in which:

FIG. 1 illustrates a first embodiment of the dental implant system, showing a side view of the combined with the abutment fitted inside the implant, and of an adjacent separate abutment. For this embodiment, the abutment has the splines and the implant side wall inward surface has the spline receiving grooves, and the mounting portion is tilted.

FIG. 1a is a cross-sectional top view of the combined abutment and implant of FIG. 1, showing the splines fitted into the spline receiving grooves.

FIG. 2 illustrates a second embodiment of the dental implant system, showing a side view of the combined with the abutment fitted inside the implant, and of an adjacent separate abutment. For this embodiment, the abutment has the spline receiving grooves and the implant side wall inward surface has the splines, and the mounting portion is entirely vertical.

FIG. 2a is a cross-sectional top view of the combined abutment and implant of FIG. 2, showing the splines fitted into the spline receiving grooves.

FIG. 3 is a side view of the preferred implant, showing the implant external thread.

FIG. 3a is a top view of the implant of FIG. 3.

FIG. 3b is a bottom view of the implant of FIG. 3.

FIG. 4 is a cross-sectional side view of the preferred implant of FIG. 3, showing the internal bevel and internal grooves.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and to functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

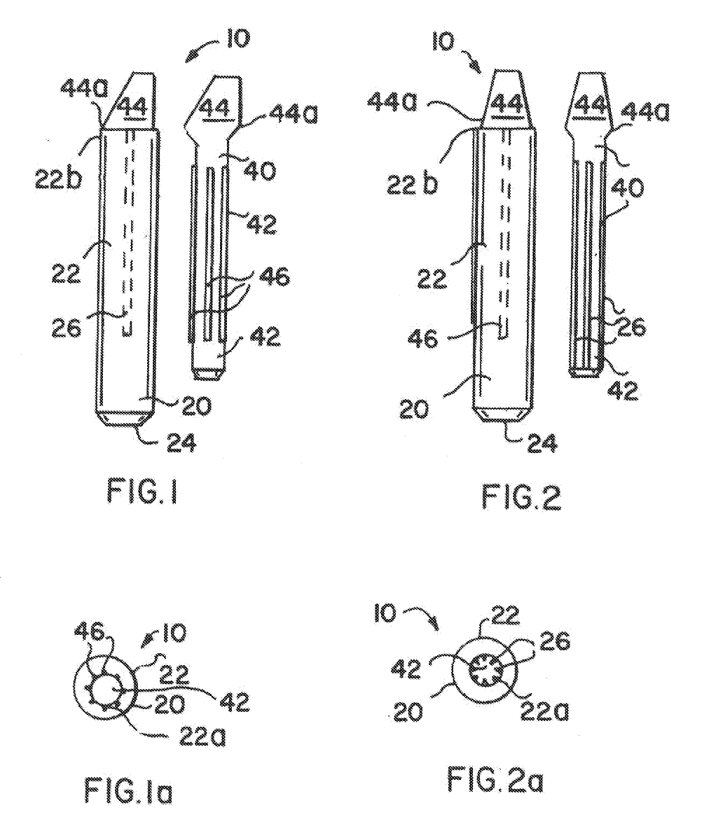

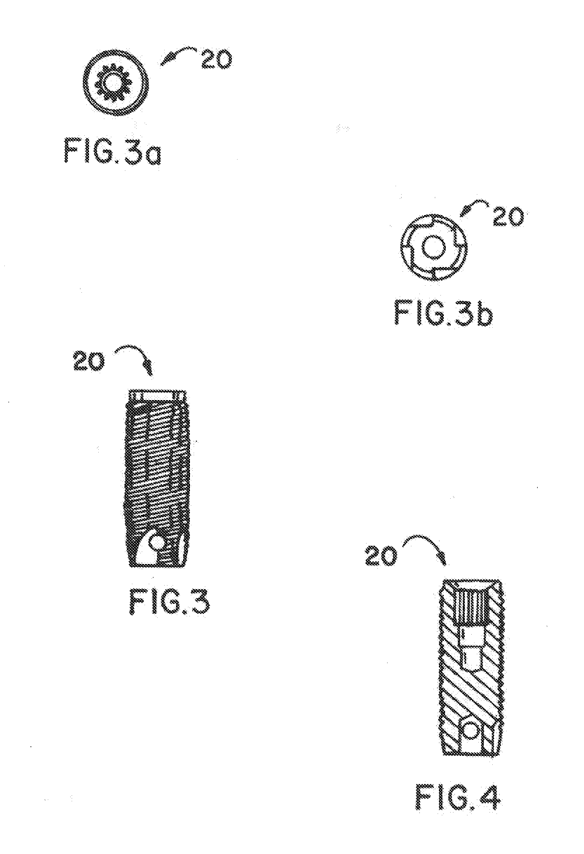

Referring to FIGS. 1-4, an endo-post dental implant system 10 is disclosed including an implant 20 having a tubular implant side wall 22 and an implant bottom wall 24 sealingly secured to the implant side wall 22 for surgical insertion into the jaw of the patient and including an abutment 40 for insertion into the implant 20 after the jaw heals. The implant side wall inward surface 22a has a circumferential series of longitudinally extending spline receiving grooves 26 and the abutment 40 includes a cylindrical abutment anchor portion 42 having a matching number of splines 46 arrayed in circumferential series which slide into corresponding the spline receiving grooves 26 as the abutment 40 is inserted into implant 20, securely retaining the abutment 20 against rotation relative to the implant 20 and jaw. It is alternatively contemplated that the implant side wall inward surface 22a have the splines 46 and the abutment anchor portion 42 optionally have the spline receiving grooves 26. See FIGS. 2 and 2a. The present splines 46 extend substantially the entire length of the post or abutment 40 or substantially the entire length of the abutment anchor portion 42 and are engaged by the grooves 26 in the implant 20 so that the forces carried by the implant 20 during use, i.e. chewing, are broadly dissipated by the abutment 40 over virtually the full length of the implant 20. As a result, force and stress is not concentrated at any particular point or region and the abutment 40 is thus secure against fracture, whether the abutment 40 is angled or straight. There are no discontinuities or other stress risers such as screw threads or bores to invite fracture.

The self-locking splines have an E-Z Grip or Auto Grip characteristic. The abutment 40 is thereby secured within the implant 20′without use of a screw or any other threaded fastening means. As a result, the abutment 40 is a solid cylinder having maximum tensile and sheer strength because no screw bore is needed, and the abutment 40 is secured quickly and easily without need of fastener securing tools. The implant 20 preferably is formed of a titanium alloy.

The abutment 40 is secured within the implant with a tri-support seal S to minimize micromovement and thus to enhance stability and to transfer occusol forces longitudinally down the implant. The tri-support seal has apical, longitudinal and coronal aspects.

The apical aspect of the tri-support seal S includes a abutment pilot tip 48 which fits with close tolerance into a corresponding implant internal bevel 32 at the implant embedded end 30. The abutment pilot tip 48 and the implant internal bevel 32 serve to properly self-center the abutment 40 during insertion and to enhance abutment 40 strength and to make insertion easy because the bevel 32 causes smooth and centered entry regardless the initial contact point between the top rim of the implant 20 and the bottom distal to end of the abutment 40.

The longitudinal aspect of the tri-support seal S includes the above referenced, mutually engaging equally numbered spline and groove structures 46 and 26, respectively, between the implant 20 and abutment 40.

The coronal aspect of the tri-support seal S includes an anti-intrusion bio-seal. The bio-seal preferably involves simply machining the abutment 40 and the implant 20 with close tolerances so that they fit together precisely.

There is no need to counterbore or countersink, and thus no counterbore or countersink tooling is required. Drill to the implant support platform size of 3 mm-6 mm or more, but these sizes are merely exemplary and are not to be construed as limiting. The major diameter of the external thread is designed to support this feature. It is larger than the support platform.

The abutment 40 has a prosthetic tooth mounting portion 44 preferably integral with and extending upwardly from the abutment anchor portion 42 having a truncated rectangular cross-section pyramid shape. The mounting portion 44 preferably is vertically upright, as shown in FIG. 2. Yet for instances of divergent implant installation, whether intentional or by accident, in which the implant 20 is to be placed into the jaw at an angle, the tooth mounting portion 44 optionally is tilted to compensate for this angle, as shown in FIG. 1. The implant side wall 22 has a side wall upper end 22b and tooth mounting portion 44 has a mounting portion base 44a which preferably is wider than the anchor portion 42 to abut the implant side wall upper end 22b and which fits into a correspondingly shaped opening in the lower end of a prosthesis tooth or crown (not shown). A lateral hole in mounting portion 44 may receive an abutment 40 removal wire.

The implant 20 preferably has implant external threads 28 which preferably are quick-seat external threads having a high pitch so that the implant 20 seats with as few as two rotations, rather than fifteen for example. The preferred pitch is 0.240, although this particular pitch should not be viewed as limiting because many other pitches are contemplated as well. Another preferred characteristic of the implant external threads 28 is that they be multi-helix threads. This means that each thread has a wide enough spacing between its revolutions about the implant 20 that one or more additional and matching threads 28 can be interspersed between the given thread in parallel relation. Multi-helix threads 28 have the advantage of multiple starts at the implant 20 inserted end, for circumferentially distributed points of jawbone engagement for even and balanced bite and advancement, and multiplied engagement strength. The implant 20 preferably has a multi-flute, implant tapered self-tapping apical point 34 to more easily bore into and seat itself within the jaw bone.

In summary, preferred features of dental implant system 10 include: quick-seat external thread (implant body only), preferably although not necessarily 0.240 pitch (6 mm); multi-helix thread-accutrak; 2-12 internal involute tapered female splines; tri-support seal-minimize micromovement enhance stability: (a) apical, (b) longitudinal, (c) coronal; anti-intrusion bio-seal; multi-flute tapered self-tapping apical point; optional coronal external taper lock; optional “no c'bore-c'sink” thread diameter;

screwless abutment (prosthetic) retention (screw-free) and internal bevel-self centering.

### Multiple. Implant with Try-In Heads or with Single Tooth Replacement and Try-In Head

The present prosthetic system, series 1, includes temporary prosthesis heads, hereinafter try-in heads, for parallelism in multiple abutment crown and bridge cases. The try-in heads are 0 degrees, 15 degrees, and 25 degrees. Each try-in head fits into an existing implant 20 and is a fraction smaller than the final abutment 40 head. The try-in heads are used to see proper alignment and become impression heads, and then final heads are provided which are slightly larger.

### Method of Installation Using Temporary Prosthesis Correction Heads

In practicing the invention, the following method may be used. The procedural prosthetic method includes the following steps: selecting a try-in head that best fits the multiple parallelism of the adjoining implants, multiple positions and angulations are available; placing as many try-in heads as implants present; using the naked eye positioning all heads as close to parallel as the trained eye of the dentist allows, such as by rotating angled try-in heads to an optimum position and then sliding splines into grooves to engage the head at that position; placing all necessary heads so that the try-in heads become crown and bridge impression heads; taking an impression of the heads; sending the impression to a laboratory with the try-in heads in place in the impression; a laboratory technician then replacing the try-in heads with final abutment heads in the exact same position taken by the try-in heads in the impression; making final paralleling techniques and adjustments necessary on final abutment heads on a stone model; and forming a temporary matrix from a suitable temporary material such as dental acrylic, the matrix serving to seat final heads into the mouth and act as a temporary bridge while a final case is being constructed, the laboratory returning the temporary bridge matrix to the D.D.S. with the parallel abutment heads; an implantologist-prosthodontics or dentist placing the final heads with the use of the temporary matrix bridge onto the existing implants with finger pressure in the mouth; removing the temporary matrix final bridge; tapping the final abutment heads to their final seating place; taking final crown and bridge impression, (the abutment heads are treated as standard crown and bridge and impression is taken); such that the patient leaves with the temporary bridge in place; following standard procedures in crown and bridge dentistry to complete the case. Then the try-in heads are returned to the original DDS to be placed back into inventory for use in other cases.

An alternative method or procedure to the one set forth above is provided in which, when try-in heads are placed by the restoring Dentist, and if all heads are deemed parallel: removing the try-in heads; places and tapping the final abutment heads to their final seating places; applying copious coolant to achieve the final parallelism; taking a final impression at this Appointment; and constructing a temporary bridge.

For single tooth replacement, the above steps are followed with try-in heads used at appointment for uncovering the implant; and a decision is made with try-in heads as to closest final abutment head; once final try-in head is selected: selecting and tapping the final fixed head to place; taking a final crown and bridge impression; constructing a temporary crown'and then dismissing the patient; cementing the final crown into place during a and final delivery appointment with the patient.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A method of prosthetic installation using temporary, prosthesis head of one of several angles, comprising the steps of:
selecting a temporary prosthesis head that best fits the multiple parallelism of the adjoining implants;
placing as many temporary prosthesis heads as implants present;
using the naked eye positioning all heads as close to parallel as the trained eye of the dentist allows, such as by rotating angled temporary prosthesis heads to an optimum position and then sliding splines into grooves to engage the head at that position;
placing all necessary heads so that the temporary prosthesis heads become crown and bridge impression heads;
taking an impression of the heads; sending the impression to is a laboratory with the temporary prosthesis heads in place in the impression; a laboratory technician then replacing the temporary prosthesis heads with final abutment heads in the exact same position taken by the temporary prosthesis heads in the impression;
making final paralleling techniques and adjustments necessary on final abutment heads on a stone model;
and forming a temporary matrix from a suitable temporary material, the matrix serving to seat final heads into the mouth and act as a temporary bridge while a final case is being constructed;
the laboratory returning the temporary bridge matrix with the parallel abutment heads;
placing the final heads with the use of the temporary matrix bridge onto the existing implants with finger pressure in the mouth;
removing the temporary matrix final bridge;
tapping the final abutment heads to their final seating place;
taking final crown and bridge impression, such that the patient leaves with the temporary bridge in place;
completing the case following standard procedures in crown and bridge dentistry.

2. The method of claim 1, wherein when temporary prosthesis heads are placed, and when all heads are deemed parallel, the steps of: removing the temporary prosthesis heads;
placing and tapping the final abutment heads to their final seating places;
applying copious coolant to achieve the final parallelism;
taking a final impression at this appointment;
and constructing a temporary bridge.

3. The method of claim 1, wherein, for single tooth replacement and once final temporary prosthesis head is selected, comprising the steps of:
selecting and tapping the final fixed head to place;
taking a final crown and bridge impression;
constructing a temporary crown and then dismissing the patient;
and cementing the final crown into place during a and final delivery appointment with the patient.
